(19) United States
(12) Patent Application Publication
(10) Pub. No.: US 2016/0133885 A1
(43) Pub. Date: May 12, 2016

(54) SECONDARY BATTERY

(71) Applicant: SHARP KABUSHIKI KAISHA, Osaka (JP)

(72) Inventors: Kazuya SAKASHITA, Osaka (JP); Kazuo YAMADA, Osaka (JP); Yoshihiro TSUKUDA, Osaka (JP); Yuki WATANABE, Osaka (JP); Hiroshi OKAMOTO, Osaka (JP); Tadashi NEMOTO, Osaka (JP); Takuya OOTANI, Osaka (JP)

(73) Assignee: SHARP KABUSHIKI KAISHA, Osaka (JP)

(21) Appl. No.: 14/982,160

(22) Filed: Dec. 29, 2015

Related U.S. Application Data
(62) Division of application No. 13/286,368, filed on Nov. 1, 2011.

(30) Foreign Application Priority Data
Nov. 2, 2010 (JP) 2010-245925
Jun. 1, 2011 (JP) 2011-123453

(51) Int. Cl. H01M 2/04; H01M 10/0525; H01M 2/30

(52) U.S. Cl. CPC H01M 2/04; H01M 2/30; H01M 10/0525; H01M 2/0404; H01M 2/043; H01M 2220/20; H01M 2220/30

(57) ABSTRACT

To obtain a secondary battery that surely positions and fixes a laminated type of electrode group by effectively curbing lateral deviation and vertical deviation, in secondary batteries RB1 to RB11 that include a laminated type of electrode group 1 in which a positive-electrode plate 2 and a negative-electrode plate 3 are so laminated via a separator 4 as to form a plurality of laminated layers, a structure is employed, in which vertical deviation in a lamination direction and lateral deviation in a lamination surface direction are curbed via a fix means that fixes the electrode group 1 to a predetermined position in an outer case 11 that houses the electrode group 1.

This application is a continuation of U.S. patent application Ser. No. 13/286,368, filed Nov. 1, 2011, which in turn claims priority and benefit of Japanese Patent Application No. 2010-245925 filed on Nov. 2, 2010 and Japanese Patent Application No. 2011-123453 filed on Jun. 1, 2011, the contents of each of which are hereby incorporated by reference.

### BACKGROUND OF THE INVENTION

1. Field of the Invention

The present invention relates to a secondary battery, more particularly, to a secondary battery that is able to surely fix a laminated type of electric group, in which a positive-electrode plate and a negative-electrode plate are alternately laminated, to a predetermine position of a battery can.

2. Description of Related Art

In recent years, a lithium secondary battery has a high energy density and is able to achieve size and weight reductions, so that it is known as a power-supply battery for mobile electronic apparatuses such as a mobile phone, a notebook computer and the like. Besides, the lithium secondary battery is able to achieve size increase, so that it is attracting attention as a motor drive power supply for an electric vehicle (EV), a hybrid electric vehicle (HEV) and the like and as an electricity storage accumulator.

The above lithium battery has a structure which includes: an electrode group that has a positive-electrode plate and a negative-electrode plate oppositely disposed with a separator interposed and is housed in an inside of an outer case that constitutes a battery can; an electrolyte that is injected therein; a positive-electrode electricity collection terminal connected to a positive-electrode electricity collection tab for a plurality of positive-electrode plates; a positive-electrode external terminal electrically connected to the positive-electrode electricity collection terminal; a negative-electrode electricity collection terminal connected to a negative-electrode electricity collection tab for a plurality of negative-electrode plates; and a negative-electrode external terminal electrically connected to the negative-electrode electricity collection terminal.

Besides, as the electrode group, a wound type and a laminated type are known. A wound type of electrode group has a structure in which a positive-electrode plate and a negative-electrode plate are unitarily wound with a separator interposed between the positive-electrode plate and the negative-electrode plate, while a laminated type of electrode group has a structure in which a positive-electrode plate and a negative-electrode plate are so laminated as to form a plurality of layers via a separator.

A lithium secondary battery including the laminated type of electrode group has a structure in which a positive-electrode plate and a negative-electrode plate are so laminated via a separator to form a plurality of layers, and a nonaqueous electrolyte is injected; and there disposed are: a positive-electrode electricity collection terminal that is connected to a positive-electrode electricity collection tab for the positive-electrode plates; an external terminal electrically connected to the positive-electrode electricity collection terminal; a negative-electrode electricity collection terminal that is connected to a negative-electrode electricity collection tab for the negative-electrode plates; and an external terminal electrically connected to the negative-electrode electricity collection terminal

Besides, in the lithium secondary battery including the laminated type of electrode group, if external force such as vibration and the like is exerted, there are risks that the electrode group is displaced, whereby a connection state between the electricity collection terminal and the external terminal deteriorates; and the laminated electrode plates deviate to cause an electric short.

Because of this, a secondary battery is already disclosed, which has a structure in which at least one of the positive-electrode plate, the negative-electrode plate and the separator is fixed to a support member of the electrode group to position the laminated electrode group in a battery container; the laminated electrode group is not moved in the battery container by vibration and the like, so that the positive-electrode plate and the negative-electrode plate are prevented from being damaged (e.g., patent document: JP-A-2006-66319).

Besides, a nonaqueous secondary battery (e.g., patent document: JP-A-2001-266842) is already disclosed, which has a structure in which an external lead, which is extended from the electrode group to outside of the outer case, is bent between the electrode group and the outer case; and even if fall and vibration are repeated, damage to the external lead is preventable.

To enlarge the capacity of the secondary battery that has the positive-electrode plate, the negative-electrode plate and the electrolyte and to prolong the battery life, it is preferable to enlarge the power generation area and increase the amount of the injected electrolyte; accordingly, there is a tendency that the number of laminated layers is increased and the amount of the injected electrolyte is increased. According to this, the capacity of the outer case which constitutes the battery can becomes large and a gap between the electrode group and the outer case becomes large, which causes a state in which the electrode group is likely to be moved by external force such as vibration and the like.

If external force such as vibration and the like is exerted on the outer case and the electrode group is moved, the connection between the positive-electrode (negative-electrode) electricity collection terminal and the positive-electrode (negative-electrode) external terminal is damaged, whereby it becomes impossible to obtain a predetermined battery capacity, which is a problem. Besides, if the electrode group is displaced in a lamination direction, the pressurized distance between the positive-electrode plate and the negative-electrode plate changes, so that a problem occurs, in which the predetermined battery capacity is not achieved.

Because of this, in the laminated type of secondary battery which includes the electrode group in which many (e.g., several tens of layers) positive-electrode plates, negative-electrode plates and separators are laminated, it is desired that when external fore such as vibration and the like is exerted, the electrode group is effectively prevented from being moved in an electricity collection terminal direction; and each of the electrode plates does not go away in the lamination direction nor deviate in the surface direction. Besides, it is preferable that all of the laminated positive-electrode plates, the negative-electrode plates and the separators are positioned such that they do not deviate in the lamination direction and the surface direction perpendicular to the lamination direction.

Because of this, like in the secondary battery described in the patent document 1, it is not enough if any one only of the positive-electrode plate, the negative-electrode plate and the separator is fixed to the electrode group support member. Moreover, in the laminated type of secondary battery, it is desired that besides lateral deviation in the surface direction, vertical deviation in the lamination direction is also curbed such that the electrode group, which is composed by laminating the many electrode plates, is stably positioned and fixed.

### SUMMARY OF THE INVENTION

Accordingly, in light of the above problems, it is an object of the present invention to provide a secondary battery that effectively curbs lateral deviation and vertical deviation of a laminated type of secondary battery, and surely positions and fixes the electrode group.

To achieve the above object, a secondary battery according to the present invention is a secondary battery that includes:

an electrode group in which a positive-electrode plate, a negative-electrode plate are so laminated via a separator to form a plurality of layers;

an outer case in which the electrode is housed and an electrolyte is injected;

an external terminal disposed through the outer case;

positive and negative electricity collection terminals which electrically connect the positive- and negative-electrode plates to the external terminal; and

a lid member that is disposed on the outer case;

wherein a fix member, which fixes the electrode group to a predetermined position in the outer case, is disposed.

According to this structure, it becomes possible to unitarily position and fix the laminated type of electrode group. Because of this, even in a structure in which the electrode group is housed in a large battery can for a large capacity, it is possible to obtain the secondary battery that effectively curbs deviation, surely positions and fixes the electrode group.

Besides, in the secondary battery having the above structure according to the present invention, a lamination surface of the electrode group is disposed in parallel with a bottom surface of the outer case; and the fix member includes a lateral deviation curb member that butts a side surface portion of the electrode group that rises from the bottom surface to position and fix the electrode group. According to this structure, even in the laminated type of secondary battery that has a large area, it is possible to curb lateral deviation in a lamination surface direction via the lateral deviation curb member.

Besides, in the secondary battery having the above structure according to the present invention, the fix member includes a vertical deviation curb member that curbs displacement in the lamination direction of the electrode group. According to this structure, even in the electrode group that has a large dimension in a thickness direction, it is possible to effectively curb vertical deviation in the lamination direction via the vertical deviation curb member.

Besides, in the secondary battery having the above structure according to the present invention, the electrode group includes a lower surface portion that is disposed on the bottom surface of the outer case; an upper surface portion that is opposite to the lid member; and a side surface portion between the lower surface portion and the upper surface portion; wherein a lateral deviation curb member, which curbs a surface-direction positional deviation of the electrode group, is disposed at at least two opposite side surfaces of the side surface portion; and a vertical deviation curb member, which curbs a lamination-direction displacement of the electrode group, is disposed on the upper surface portion. According to this structure, it is possible to effectively curb lateral deviation and vertical deviation of the electrode group that is housed in the outer case, so that it becomes possible to unitarily position and fix the laminated type of electrode group. Besides, it is possible to curb detachment of the laminated electrode plate and the separator and pressurize them in the lamination direction by using a suitable pressure. Because of this, it is possible to obtain the secondary battery that is able to achieve a predetermined battery capacity.

Besides, in the secondary battery having the above structure according to the present invention, the lateral deviation curb means is disposed between a side surface on which the electricity collection terminal is disposed and an inner surface of the outer case opposite to the side surface. According to this structure, it is possible to surely position and fix the electricity collection terminal and the external terminal via the lateral deviation curb means such that a connection portion between the electricity collection terminal and the external terminal is not displaced.

Besides, in the secondary battery having the above structure according to the present invention, both of the lateral deviation curb member and the vertical deviation curb member are formed of a foam material that has an insulation characteristic. According to this structure, electric insulation between the battery can and the electrode group is achieved. Besides, it is possible to curb lateral deviation and vertical deviation by means of a suitable force by using the foam material that has suitable compressibility and flexibility.

Besides, in the secondary battery having the above structure according to the present invention, the lateral deviation curb member and the vertical deviation curb member are composed of a unitary step-shape fix member; the step-shape fix member includes: a bottom portion that butts the side surface of the electrode group and the inner surface of the outer case; a side portion that butts the side surface; and an upper portion that butts the upper surface of the electrode group. According to this structure, it is possible to dispose the step-shape fix member oppositely to both side surfaces of the electrode group, surely position and fix the electrode group into the outer case by curbing both of lateral deviation in the surface direction and vertical deviation in the lamination direction.

Besides, in the secondary battery having the above structure according to the present invention, the lateral deviation curb member and the vertical deviation curb member are composed of unitary stool-shape fix member; the stool-shape fix member includes: a bottom portion that butts the side surface of the electrode group and the inner surface of the outer case; a side portion that butts the side surface on both sides thereof; an upper portion that connects the side portions to each other and butts the upper surface of the electrode group; and a concave portion that unitarily houses the electrode group. According to this structure, by means of the stool-shape fix member, it is possible to surely position and fix the electrode group into the outer case by curbing both of lateral deviation in the surface direction and vertical deviation in the lamination direction.

Besides, in the secondary battery having the above structure according to the present invention, the upper portion is pressurized to the electrode group by the lid portion. According to this structure, when the lid member is fixed, the lid member pressurizes the upper portion by means of a suitable pressure, whereby a structure, in which the positive-electrode plate and the negative-electrode plate of the electrode group are pressurized to each other by means of a suitable pressure, is composed, so that detachment of the positive-electrode plate and the negative-electrode plate does not occur and it is possible to exactly achieve a predetermined power generation capacity.

Besides, in the secondary battery having the above structure according to the present invention, the vertical deviation curb member includes a member that has electrolyte permeability; and the lateral deviation curb member is composed of a concave and convex portion formed on the bottom surface of the outer case. According to this structure, by using the vertical deviation curb member that pressurizes the electrode group in the lamination direction and the concave and convex portion disposed on the bottom surface of the outer case, it is possible to easily position and fix the electrode group into the outer case by curbing both of lateral deviation in the surface direction and vertical deviation in the lamination direction. Besides, the vertical deviation curb member includes the material that has the electrolyte permeability, so that the material does not discourage the electrolyte from permeating from the upper surface portion of the electrode group and it is possible to surely let the electrolyte permeate into the inside of the electrode group.

Besides, in the secondary battery having the above structure according to the present invention, the vertical deviation curb member includes the member that has the electrolyte permeability; and the lateral deviation curb member is composed of a concave and convex member disposed on the bottom surface of the outer case. According to this structure, by using the vertical deviation curb member that pressurizes the electrode group in the lamination direction and the concave and convex member that is disposed on the bottom surface of the outer case, it is possible to easily position and fix the electrode group into the outer case by curbing both of lateral deviation in the surface direction and vertical deviation in the lamination direction. Besides, the vertical deviation curb member includes the material that has the electrolyte permeability, so that the material does not discourage the electrolyte from permeating from the upper surface portion of the electrode group and it is possible to surely let the electrolyte permeate into the inside of the electrode group.

Besides, in the secondary battery having the above structure according to the present invention, a lamination fixture for housing the electrode group in advance is disposed as the fix member; the electrode group is housed and fixed into the lamination fixture and is unitarily disposed into the outer case; the lamination fixture includes: an inner surface that butts and supports at least two opposite side surfaces of the side surface portion of the electrode group; and an outer surface that butts an inner surface of the outer case, positions and fixes surfaces that correspond to the two side surfaces. According to this structure, the lamination fixture performs a lateral deviation curb function, so that it is possible to unitarily position and fix the electrode group.

Besides, in the secondary battery having the above structure according to the present invention, the lamination fixture is formed of a material that has electrolyte permeability. According to this structure, even in the structure in which the electrode group is housed in the lamination fixture in advance, it is possible to let the electrolyte permeate into the inside of the electrode group by injecting the electrolyte after the electrode group is built into the outer case.

Besides, in the secondary battery having the above structure according to the present invention, the electrode group is disposed with the lamination surface thereof parallel with the bottom surface of the outer case; and as the fix member, a deviation curb member is disposed which unitarily includes: a lateral deviation curb surface that limits positional deviation of a side surface on which the electricity collection terminal of the electrode group is disposed; and a vertical deviation curb surface that curbs displacement in the lamination direction of the electrode group. According to this structure, lateral deviation of the side surface portion on which the electricity collection terminal is disposed is curbed and lateral deviation in the lamination direction is also curbed, whereby it is possible to effectively curb positional deviation of even the laminated type of electrode group, which has a large area, via the deviation curb member.

Besides, in the secondary battery having the above structure according to the present invention, the deviation curb member is formed of a pair of deviation curb plate frames that are each disposed on both side surfaces on which the electricity collection terminal of the electrode group is disposed, each of the pair of deviation curb plate frames is formed of an insulation member having an H shape in section that includes an opening portion through which the electricity collection terminal is insertable, and includes: a plate-shape lower surface limit portion that butts a lower surface portion of the electrode group; an upper surface limit portion that butts an upper surface portion of the electrode group; a side surface limit portion that limits lateral deviation of the electrode group by means of a vertical plate that connects the lower surface limit portion and the upper surface limit portion to each other. According to this structure, the deviation curb plate frame having the H shape in section is so disposed as to sandwich both side surfaces of the electrode group and unitarily built in, whereby it is possible to effectively curb positional deviation of the electrode group.

Besides, in the secondary battery having the above structure according to the present invention, the deviation curb member is formed of four deviation curb plate frames which are each disposed on both of left and right ends of both side surfaces on which the electricity collection terminal of the electrode group is disposed, each of the four deviation curb plate frames has an H shape in section, is formed of an insulation member, and includes: a small-width and piece-shape lower surface limit piece that butts the lower surface portion of the electrode group; an upper surface limit piece that butts the upper surface portion of the electrode group; and a side surface limit piece that limits lateral deviation of the electrode group by means of a vertical plate that connects the lower surface limit piece and the upper surface limit piece to each other. According to this structure, the deviation curb plate frame having the H shape in section is so disposed on the four corners of the electrode group as to sandwich both side surfaces of the electrode group and unitarily built in, whereby it is possible to effectively curb positional deviation of the electrode group.

Besides, in the secondary battery having the above structure according to the present invention, the deviation curb member is formed of a deviation curb plate frame which has a π-shape in section and an insulation characteristic, and includes: an upper surface limit portion that butts the upper surface portion of the electrode group; first and second side hang portions that hang from the upper surface limit portion and butt both side surface portions of the electrode group; and an opening portion through which the electricity collection terminal is insertable. According to this structure, the deviation curb plate frame having the π shape in section is so disposed on the electrode group as to sandwich both of the left and right side surfaces of the electrode group by means of the first and second side hang portions and unitarily built in, whereby it is possible to effectively curb positional deviation of the electrode group.

Besides, in the secondary battery having the above structure according to the present invention, the deviation curb member is formed of a pair of left and right deviation curb pieces that are each disposed on both of left and right side surfaces of the electrode group, each of the pair of left and right deviation curb pieces is formed of an insulation member which has an L shape in section, and includes: an upper surface limit piece that butts the upper surface portion of the electrode group; a side hang portion that butts the side surface portion of the electrode group. According to this structure, the deviation curb pieces having the L shape in section are each disposed on both of the left and right side surfaces of the electrode group and fixed with the upper surface pressurized by the lid member, whereby it is possible to effectively curb positional deviation of the electrode group.

Besides, in the secondary battery having the above structure according to the present invention, the lid member has a dish shape that includes a concave portion which fits into the outer case; the deviation curb piece has an engagement portion that engages with the concave portion; wherein the engagement portion and the side hang portion curb lateral deviation of the electrode group. According to this structure, the side hang portions having the L shape in section each butt both of the left and right side surfaces of the electrode group and the engagement portion engages with the concave portion of the lid member, whereby it is possible to fix the electrode group such that the electrode group is not displaced with respect to the lid member.

Besides, in the secondary battery having the above structure according to the present invention, the deviation curb member is formed of a material that has electrolyte permeability. According to this structure, even if the deviation curb member is so disposed as to touch the electrode group, the deviation curb member does not discourage the electrolyte from permeating into the electrode group and it is possible to surely let the electrolyte permeate into the inside of the electrode group.

### BRIEF DESCRIPTION OF THE DRAWINGS

FIG. 1 is a sectional view showing a first embodiment of a secondary battery according to the present invention.

FIG. 2 is a sectional view showing a second embodiment of a secondary battery according to the present invention.

FIG. 3A is a sectional view showing a third embodiment in which a convex portion is disposed on a bottom surface of an outer case.

FIG. 3B is a sectional view showing a fourth embodiment in which a concave portion is disposed on a bottom surface of an outer case.

FIG. 4A is a schematic sectional view showing a fifth embodiment in which a vertical deviation curb member and a lateral deviation curb member are disposed.

FIG. 4B is a schematic sectional view showing a sixth embodiment in which a convex portion having a vertical deviation curb member and a lateral deviation curb member is disposed.

FIG. 4C is a schematic sectional view showing a seventh embodiment in which a concave portion having a vertical deviation curb member and a lateral deviation curb member is disposed.

FIG. 5A is a schematic sectional view showing an eighth embodiment in which a lamination fixture having a lateral deviation curb function is disposed.

FIG. 5B is a side view of a lamination fixture.

FIG. 5C is a plan view of a lamination fixture.

FIG. 6A is a sectional view showing a ninth embodiment in which a deviation curb member unitarily having a vertical deviation curb surface and a lateral deviation curb surface is disposed.

FIG. 6B is a schematic perspective view showing the deviation curb member in FIG. 6A.

FIG. 6C is a schematic perspective view showing a modification that is obtained by dividing the deviation curb member in FIG. 6B.

FIG. 7A is a sectional view showing a tenth embodiment in which a deviation curb member formed of a deviation curb plate frame having a π shape in section is disposed.

FIG. 7B is a schematic perspective view showing the deviation curb member in FIG. 7A.

FIG. 8A is a sectional view showing an eleventh embodiment in which a deviation curb member or a deviation curb piece having an engagement portion that engages with a concave portion of a lid member.

FIG. 8B is a schematic perspective view showing the deviation curb piece in FIG. 8A.

FIG. 8C is a schematic perspective view showing the deviation curb member in FIG. 8A.

FIG. 9 is an exploded perspective view showing a secondary battery.

FIG. 10 is an exploded perspective view of an electrode group of a secondary battery.

FIG. 11 is a perspective view showing a finished product of a secondary battery.

FIG. 12 is a sectional view of an electrode group.

### DETAILED DESCRIPTION OF PREFERRED EMBODIMENTS

Hereinafter, embodiments of the present invention are described with reference to the drawings. Besides, the same constituent members are indicated by the same reference numbers and detailed description is suitably skipped.

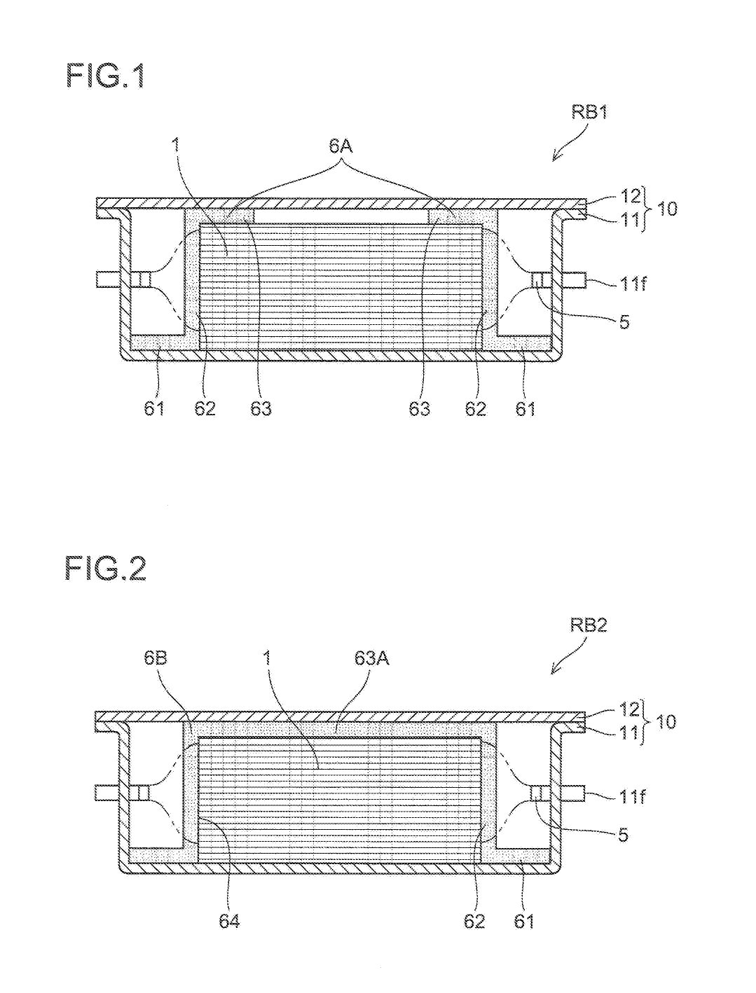

As a secondary battery according to the present invention, a lithium secondary battery is described. A lithium secondary battery RB1 according to a present embodiment shown in FIG. 1 is a laminated type of lithium secondary battery that includes a laminated type of electrode group 1 in which a positive-electrode plate and a negative-electrode plate are so laminated via a separator to form a plurality of layers. Besides, the area of the electrode plate is enlarged and the number of laminated layers is increased, whereby a relatively large capacity secondary battery is obtained and applicable to an electric vehicle storage accumulator, an electric power storage accumulator and the like.

Besides, even in a structure in which the electrode group 1 is housed in a battery can 10 enlarged for a large capacity, to surely position and fix the electrode group 1 by effectively curbing deviation of the electrode group from a disposition position, in the present embodiment, a structure is employed, in which a fix means is disposed to fix the laminated type of electrode group 1 to a predetermined position in an outer case.

A specific structure of the lithium secondary battery RB1 is, as shown in the figure, a structure in which the electrode group 1 is housed in the battery case 10 that is composed of an outer case 11 and a lid member 12; positive- and negative-electrode electricity collection terminals 5 and external terminals 11f are electrically connected to each other. The lid member 12, as shown in the figure, may have a flat-plate shape, or a dish shape in which a portion, which butts an upper surface of the electrode group 1, protrudes into a convex shape to fit into the outer case 11; the shape is suitably selected depending on the size of the battery can 10 and the thickness of the electrode group 1. In any case, it is possible to obtain a structure in which the positive-electrode plate and the negative-electrode plate of the electrode group 1 are suitably pressurized to each other via the lid member 12.

Because of this, in this secondary battery RB1, the electrode group 1 is housed into the outer case 1; thereafter, when covering and tightly closing the lid member 12, the lid member 12 is pressurized to the upper surface (a separator formed of a micro-porous film) of the electrode group 1, whereby it is possible to curb deviation (detachment of the electrode plate and the separator: called vertical deviation) in a lamination direction to some extent.

However, if the size of the electrode group 1 becomes large, the number of laminated layers of the electrode plate and the separator increases, so that unevenness in the thickness occurs and an error becomes likely to occur in the gap between the lid member 12 and the upper surface of the electrode group 1. Because of this, in a relatively small-size secondary battery, the gap error is also small, so that a structure may be employed, in which the upper surface of the electrode group 1 is directly pressurized via the lid member 12. However, in a case of a relatively large-size secondary battery, to absorb the gap error, it is preferable to interpose a predetermined-thickness vertical deviation curb member, which has compressibility and flexibility.

As the fix means that fixes the laminated type of electrode group 1 to the predetermined position in the outer case, it is preferable to dispose: a vertical deviation curb member for curbing deviation (vertical deviation) in the lamination direction of the electrode group 1; and a lateral deviation curb member for curbing deviation (lateral deviation) in a surface direction perpendicular to the lamination direction. Besides, the lateral deviation curb member and the vertical deviation curb member may be formed of members separate from each other, or a structure may be employed, in which the same member includes the lateral deviation curb member and the vertical deviation curb member.

A step-shape fix member 6A in the first embodiment shown in FIG. 1 is an example of the fix member in which the lateral deviation curb member and the vertical deviation curb member are unitarily formed, which is a structure that includes: a bottom portion 61 which butts a side surface of the electrode group 1 and an inner surface of the outer case 11; a side portion 62 which butts the side surface; and an upper portion 63 which butts the upper surface of the electrode group 1. According to this structure, the step-shape fix members 6A are disposed on both side surfaces of the electrode group 1 oppositely to each other to curb both of lateral deviation in the surface direction and vertical deviation in the lamination direction, whereby it is possible to surely position and fix the electrode group 1 in the outer case 11.

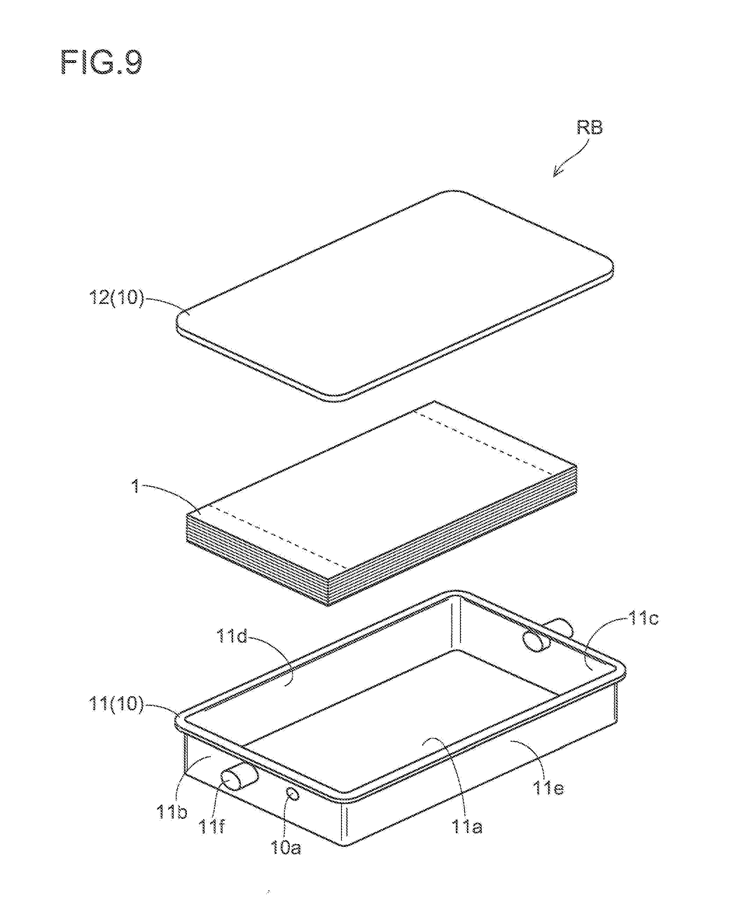

Before the fix member is described, first, specific structures of a lithium secondary battery RB and the electrode group 1 are described by using FIG. 9 to FIG. 12.

As shown in FIG. 9, the lithium secondary battery RB according to the present embodiment has a rectangular shape when viewed from top; and includes the electrode group 1 in which the positive-electrode plate, the negative-electrode plate and the separator, each of which has a rectangular shape, are laminated. Besides, a structure is employed, in which the electrode group 1 is housed in the battery can 10 that is composed of: the box-shape outer case 11 which includes a bottom portion 11a and side portions 11b to 11e; and the lid member 12, wherein electric charge and discharge are performed via the external terminal 11f that is disposed through side surfaces (e.g., two opposite side surfaces of the side surface 11b and the side surface 11c).

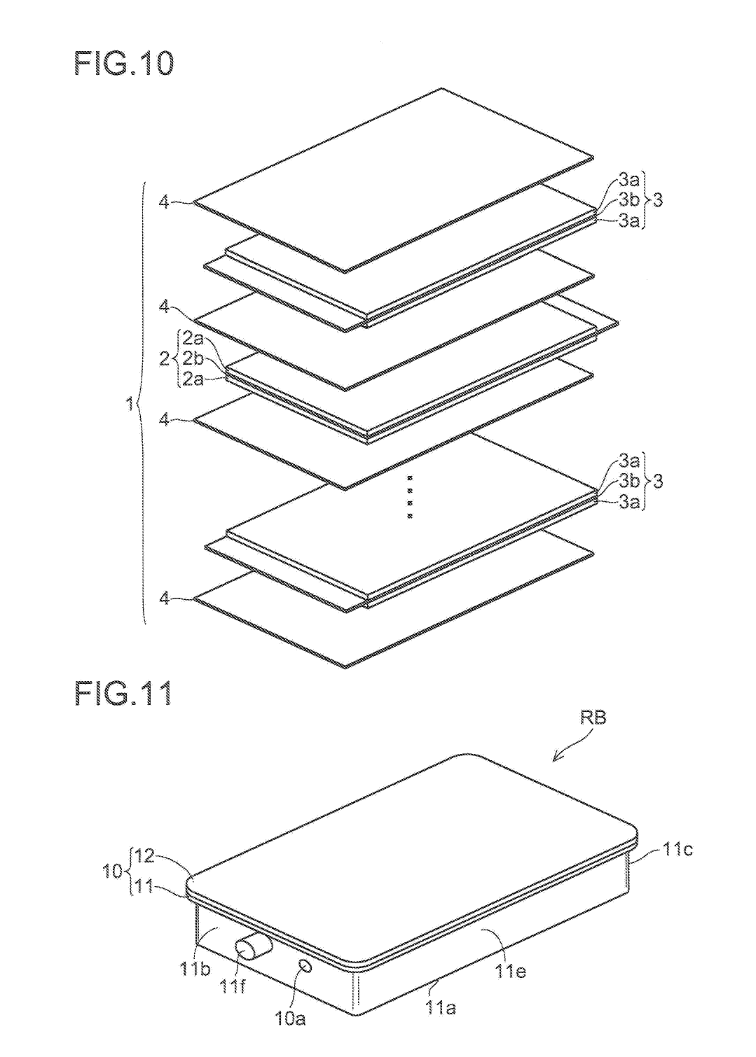

The electrode group 1 has the structure in which the positive-electrode plate and the negative-electrode plate are so laminated via the separator as to form the plurality of laminated layers; as shown in FIG. 10, there laminated via a separator 4 are: a positive-electrode plate 2 in which positive-electrode active material layers 2a are formed on both surfaces of a positive-electrode electricity collector 2b (e.g, aluminum foil); and a negative-electrode plate 3 in which negative-electrode active material layers 3a including a negative-electrode active material are formed on both surfaces of a negative-electrode electricity collector 3b (e.g, copper foil).

By means of the separator 4, insulation between the positive-electrode plate 2 and the negative-electrode plate 3 is achieved; nevertheless, lithium ions are movable between the positive-electrode plate 2 and the negative-electrode plate 3 via an electrolyte that is injected in the outer case 11.

Here, as the positive-electrode active material of the positive-electrode plate 2, there are oxides (LiCoO₂, LiNiO₂, LiFeO₂, LiMnO₂, LiMn₂O₄ and the like) that contain lithium; and chemical compounds that are obtained by replacing part of a transition metal of the above oxides with another metal element and the like. Especially, in usual use, if a material, which allows 80% or more of the lithium contained in the positive-electrode plate 2 to be used for battery reaction, is used, it is possible to increase safety against accidents such as an overcharge and the like.

Besides, as the negative-electrode active material of the negative-electrode plate 3, a material containing lithium or a material into which lithium is insertable and detachable is used. Especially, to hold a high energy density, it is preferable to use a material that has a lithium insertion/detachment potential close to the precipitation/smelting potential of metal lithium. A typical example of this is particle-like (scale-like, lump-like, fiber-like, whisker-like, ball-like, and granular powder-like) natural graphite or artificial graphite.

Here, in addition to the positive-electrode active material of the positive-electrode plate 2, and in addition to the negative-electrode active material of the negative-electrode plate 3, an electro-conductive material, a thickening agent and a binding material may be contained. The electro-conductive material is not especially limited if it is an electronic conductive material that does not adversely affect battery performance of the positive-electrode plate 2 and the negative-electrode plate 3. For example, it is possible to use: carbon-quality materials such as carbon black, acetylene black, ketjen black, graphite (natural graphite, artificial graphite), carbon fiber and the like; and an electro-conductive metal oxide and the like.

As the thickening agent, for example, it is possible to use polyethylene glycol, cellulose, polyacrylamide, polyN-vinylamide, polyN-vinyl-pyrrolidone and the like. The binding material plays a role in binding the active material particles and the electro-conductive particles; and it is possible to use: fluorine polymers such as polyvinylidene fluoride, polyvinylpyridine, polytetrafluoroethylene and the like; polyolefin polymers such as polyethylene, polypropylene and the like; styrene butadiene rubber and the like.

Besides, as the separator 4, it is preferable to use a micro-porous high-molecular film. Specifically, it is possible to use a film formed of polyolefin high molecules such as nylon, cellulose acetate, nitrocellulose, polysulfone, polyacrylonitrile, polyvinylidene fluoride, polypropylene, polyethylene, polybutene and the like.

Besides, as the electrolyte, it is preferable to use an organic electrolyte. Specifically, as an organic solvent for the organic electrolyte, it is possible to use: ester such as ethylene carbonate, propylene carbonate, butylene carbonate, diethyl carbonate, dimethyl carbonate, methyl ethyl carbonate, γ-butyrolactone and the like; ether such as tetrahydrofuran, 2-methyltetrahydrofuran, dioxane, dioxolane, diethyl ether, dimethoxyethane, diethoxyethane, methoxyethoxyethane and the like; further, dimethyl sulfoxide; sulfolane; methylsulfolane; acetonitrile; methyl formate; methyl acetate and the like. Here, these organic solvents may be used alone, or a mixture of two or more kinds of them may be used.

Further, an electrolytic salt may be contained in the organic solvent. As this electrolytic salt, there are lithium salts such as lithium perchlorate (LiClO₄), lithium tetrafluoroborate, lithium hexafluorophosphate, trifluoromethanesulfonic acid (LiCF₃SO₃), lithium fluoride, lithium chloride, lithium bromide, lithium iodide, lithium aluminate tetrachloride and the like. Here, these electrolytic salts may be used alone, or a mixture of two or more kinds of them may be used.

The concentration of the electrolytic salt is not especially limited; however, about 0.5 to about 2.5 mol/L is preferable; and about 1.0 to 2.2 mol/L is more preferable. Here, in a case where the concentration of the electrolytic salt is below about 0.5 mol/L, there is a risk that the carrier concentration becomes low in the electrolyte; and the resistance of the electrolyte becomes high. On the other hand, in a case where the concentration of the electrolytic salt is higher than about 2.5 mol/L, there is a risk that the dissociation degree of the salt itself becomes low; and the carrier concentration in the electrolyte does not rise.

The battery can 10 includes the outer case 11 and the lid member 12; and is formed of iron, iron plated with nickel, stainless steel, aluminum and the like. Besides, in the present embodiment, as shown in FIG. 11, the battery can 10 is designed such that the outer shape becomes substantially a flat rectangular shape when the outer case 11 and the lid member 12 are combined together.

The outer case 11 is so formed as to have a box shape that has the bottom portion 11a having a substantially rectangle-shape bottom surface; and the four side portions 11b to 11e that rise upright from the bottom portion 11a; the electrode group 1 is housed in the inside of the box shape. The electrode group 1 includes: a positive-electrode electricity collection terminal connected to an electricity connection tab of the positive-electrode plate; and a negative-electrode electricity collection terminal connected to an electricity connection tab of the negative-electrode plate; wherein the external terminals 11f electrically connected to the electricity collection tabs are respectively disposed on side portions of the outer case 11. The external terminals 1 if are disposed on the two opposite side portions 11b, 11c, for example. Besides, 10a indicates a liquid injection opening, from which the electrolyte is injected.

After the electrode group 1 is housed into the outer case 11 and the respective electricity collection terminals are connected to the external terminals, or after the respective external terminals are connected to the electricity collection terminals of the electrode group 1; the electrode group 1 is housed into the outer case 11; and the external terminals are fixed to predetermined positions of the outer case 11, the lid member 12 is connected to an opening edge of the outer case 11. As a result of this, the electrode group 1 is sandwiched between the bottom portion 11a of the outer case 11 and the lid member 12; and the electrode group 1 is held in the inside of the battery can 10. Here, the fixing of the lid member 12 to the outer case 11 is performed by laser welding and the like, for example. Besides, it is possible to perform the connection between the electricity collection terminal and the external terminal by using an electro-conductive adhesive and the like besides welding such as ultrasonic welding, laser welding, resistance welding and the like.

As described above, the secondary battery RB according to the present embodiment is so structured as to include: the electrode group 1 in which the positive-electrode plate 2 and the negative-electrode plate 3 are so laminated via the separator 4 as to form the plurality of laminated layers; the outer case 11 which houses the electrode group 1 and in which the electrolyte is injected; the external terminal 11f disposed through the outer case 11; the positive and negative electricity collection terminals that electrically connect the positive- and negative-electrode plates and the external terminals 11f to each other; and the lid member 12 disposed on the outer case 11.

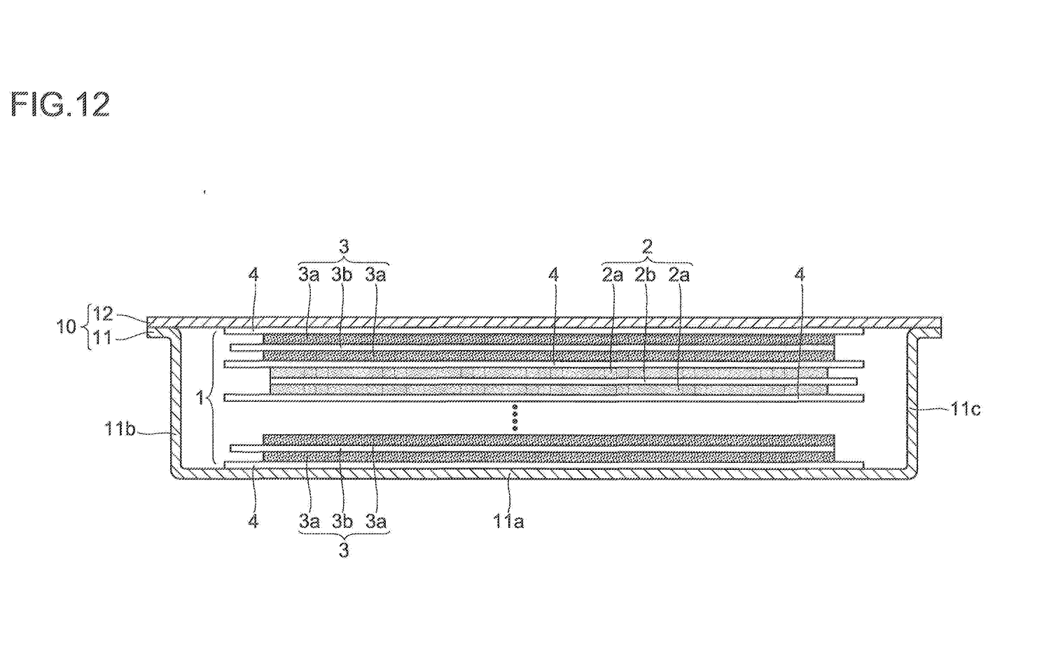

In the electrode group 1 housed in the outer case 11, for example, as shown in FIG. 12, the positive-electrode plate 2 obtained by forming the positive-electrode active material layers 2a on both sides of the positive-electrode electricity collector 2b and the negative-electrode plate 3 obtained by forming the negative-electrode active material layer 3a on both surfaces of the negative-electrode electricity collector 3b are laminated via the separator 4; further, the separators 4 are disposed on both end surfaces. Besides, a structure may be employed, in which instead of the separator 4, a resin film, which has the same material as the separator 4 and an insulation characteristic, is wound to cover the electrode group 1. In any case, a structure is obtained, in which a member, which has the electrolyte permeability and insulation characteristic, is laminated on the upper surface of the laminated electrode group 1. Because of this, it is possible to make the lid member 12 directly butt this upper surface and it is also possible to pressurize the upper surface via the lid member by means of a predetermined pressure. However, if the battery can 10 becomes large and the thickness of the electrode group 1 also becomes large, unevenness occurs in the pressurization force because of a production error; accordingly, to obtain the predetermined pressurization force, it is preferable to perform the pressurization via a flexible member that has a predetermined thickness.

Besides, because it is also desired to curb deviation in a direction parallel to the lamination direction besides a thickness direction, in the present embodiment, the structure is employed, in which there disposed are: the vertical deviation curb member for curbing deviation in the thickness direction; and the lateral deviation curb member for curbing deviation in the surface direction. In other words, in the electrode group 1 that includes: a lower surface portion that is placed on the bottom portion 11a of the outer case 11; an upper surface portion that is opposite to the lid member 12; and side surface portions between the lower surface portion and the upper surface portion, the structure is employed, in which the lateral deviation curb members for curbing positional deviation in the surface direction of the electrode group 1 are disposed on at least two opposite side surfaces of the side surface portions; the vertical deviation curb member for curbing displacement in the lamination direction of the electrode group 1; wherein the electrode group 1 is firmly held in the outer case 11 such that the electrode group 1 is not displaced even if external force such as vibration and the like is exerted on the electrode group 1.

Next, embodiments (first to eighth embodiments) of the lateral deviation curb member and the vertical deviation curb member, which fix the electrode group 1, are described by using FIG. 1 to FIG. 5.

The secondary battery RB1 according to the first embodiment shown in FIG. 1 is the embodiment in which the step-shape fix members 6A are respectively disposed on the opposite two side surfaces of the side surfaces of the electrode group 1 that is housed in the outer case 11; wherein positional deviation in the surface direction of the electrode group 1 is curbed via the step-shape fix member 6A. Besides, the width of the step-shape fix member 6A may be a width that is about the same width as the width of the side surface portion of the electrode group 1, or may be a longer width or a shorter width than this.

The step-shape fix member 6A includes: the bottom portion 61 that butts the side surface of the electrode group 1 and the inner surface of the outer case 11; the side portion 62 that butts the side surface of the electrode group 1; and the upper portion 63 that butts the upper surface of the electrode group 1. The bottom portion 61 serves as a spacer that fills the gap between the electrode group 1 and the outer case 11. Besides, the bottom portion 61 and the side portion 62 that butts the side surface of the electrode group 1 constitute the lateral deviation curb member that curbs lateral deviation of the electrode group 1, while the side portion 62, extending to the bottom portion 61, and the upper portion 63 constitute the vertical deviation curb member that curbs vertical deviation of the electrode group 1.

Besides, it is preferable that the step-shape fix member 6A includes suitable compressibility and flexibility; and is formed of a foam material that has compressibility and flexibility to curb lateral deviation and vertical deviation by means of a suitable force. Besides, it is preferable that the step-shape fix member 6A has an insulation characteristic to achieve electrical insulation between the battery can 10 and the electrode group 1.

According to the above structure, the step-shape fix members 6A are so disposed oppositely to each other on both side surfaces of the electrode group 1 as to curb lateral deviation in the surface direction and vertical deviation in the lamination direction, whereby it is possible to surely position and fix the electrode group 1 into the outer case 11.

Here, it is preferable that the side surface, on which the step-shape fix member 6A is disposed, is the side surface on which the electricity collection terminal of the electrode group 1 is disposed. Because of this, the structure is employed, in which the opening portion for exposing the above electricity collection terminal is disposed through the side portion 62. According to this structure, it is possible to curb the electrode group 1 moving in a terminal direction; and surely position and fix the electricity collection terminal and the external terminal such that the connection portion between the electricity collection terminal and the external terminal is not displaced, so that even if external force such as vibration and the like is exerted, the connection portions between the positive- and negative-electrode plates and the electricity collection terminals and the connection portion between the electricity collection terminal and the external terminal are not damaged; and the electrical connection is surely maintained.

Besides, the upper portion 63 is suitably pressurized by using the lid member 12, whereby it is possible to achieve a better vertical deviation curb function. Because of this, according to this structure, the lid member 12 and the upper portion 63 constitute the vertical deviation curb member, whereby it is possible to effectively curb deviation and detachment of the positive- and negative-electrode plates.

Besides, a secondary battery RB2 according to a second embodiment shown in FIG. 2 may be used, which includes a stool-shape fix member 6B that has a structure in which the upper portions of a pair of left and right step-shape fix members are connected to each other.

The stool-shape fix member 6B is so structured as to include: a bottom portion 61 which butts a side surface of the electrode group 1 and an inner surface of the outer case 11; a side portion 62 which butts the side surface of the electrode group 1; an upper portion 63A which connects the side portions to each other and butts the upper surface of the electrode group 1; and a concave portion 64 which unitarily houses the electrode group 1. Besides, the stool-shape fix member 6B is formed of a foam material that has suitable compressibility and flexibility.

Because of this, a structure is employed, in which the electrode group 1 is completely covered via the concave portion 64, whereby it is possible to curb lateral deviation in the surface direction and vertical deviation in the lamination direction of the electrode group 1; and surely position and fix the electrode group 1 into the outer case 11.

The above stool-shape fix member 6B is also the embodiment in which the lateral deviation curb member and the vertical deviation curb member are unitarily formed with each other. Besides, it is possible to achieve a better vertical deviation curb function by suitably pressurizing the upper portion 63A by using the lid member 12. Because of this, according to this structure, the lid member 12 also serves as a member that constitutes the vertical deviation curb member.

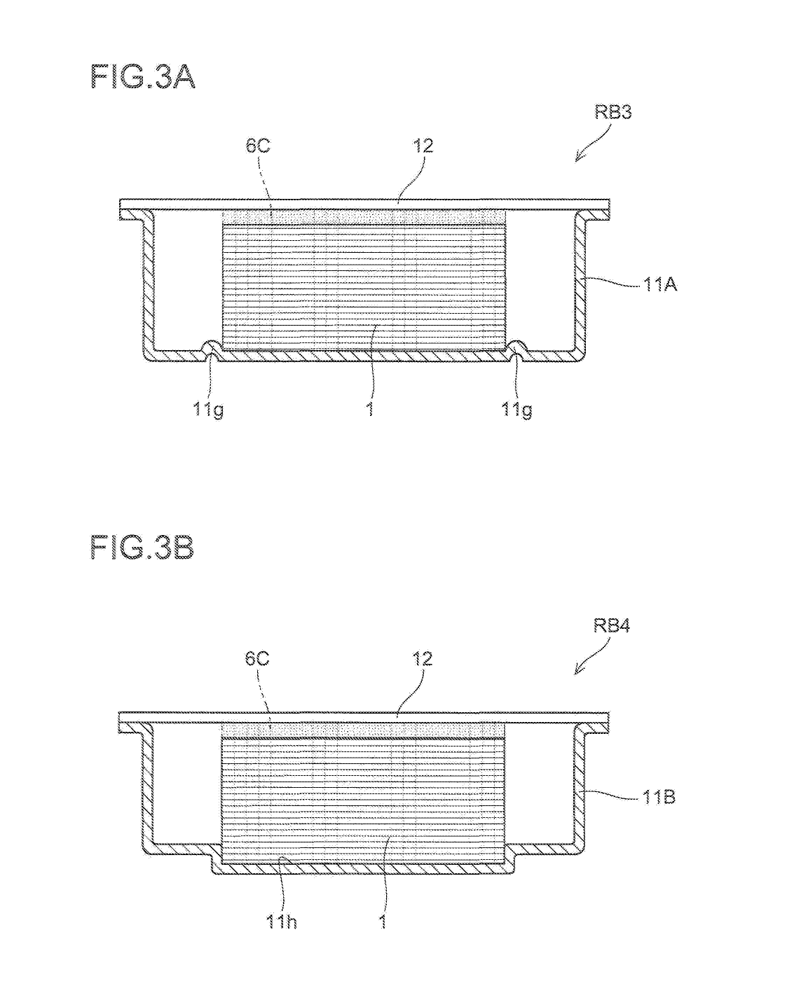

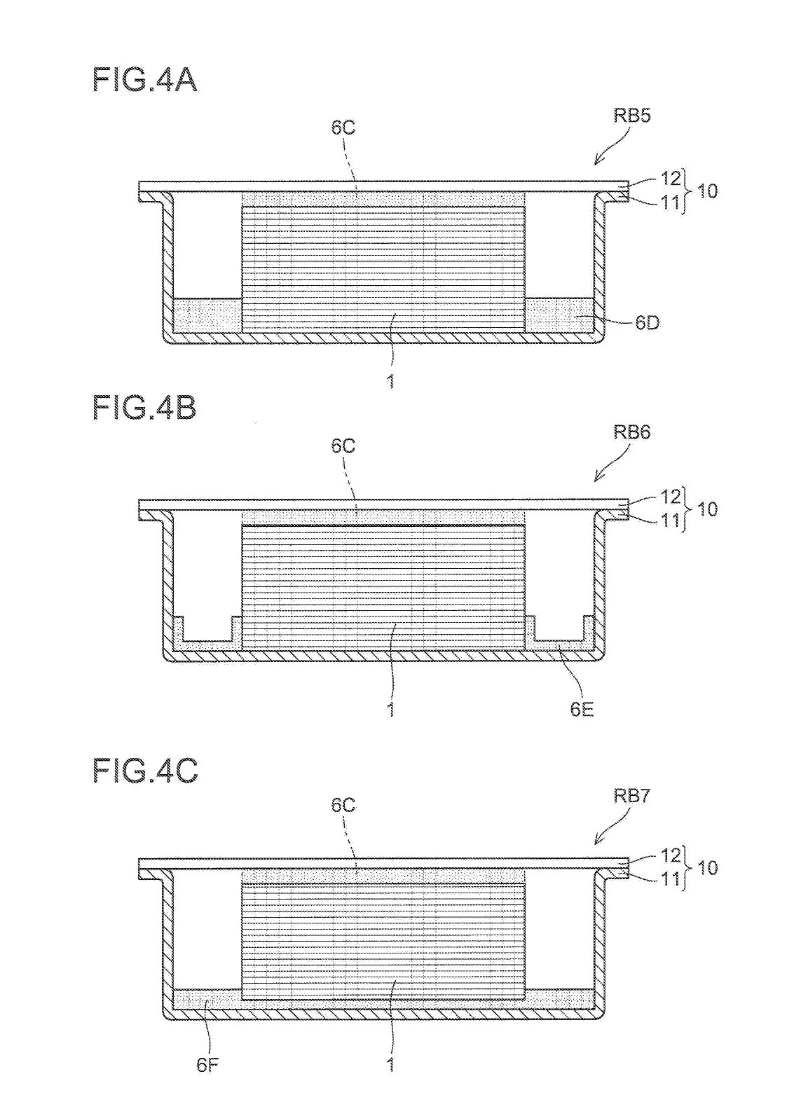

According to the structure that uses the lid member 12 as the vertical deviation curb member, it is possible to exert a predetermined pressure in the lamination direction of the electrode group 1 and achieve a curb effect in the lateral deviation direction as well. Because of this, the lateral deviation curb member may have a structure other than the structure that curbs lateral deviation of the entire side surface of the electrode group 1; for example, a structure may be used, which uses: a concave and convex surface that is formed on the bottom surface of the outer case 11 as shown in FIG. 3A and FIG. 3B; or a fix member that limits a side surface near the bottom surface of the electrode group 1 as shown in FIG. 4A, FIG. 4B and FIG. 4C.

A secondary battery RB3 according to a third embodiment shown in FIG. 3A is an example that uses an outer case 11A which is provided with a convex position limit portion 11g on a bottom surface. The position limit portion 11g linearly protrudes in a width direction of the electrode group 1, thereby limiting movement in a lateral direction of the electrode group 1. Besides, a structure may also be employed, in which the upper surface of the electrode group 1 is pressurized via the lid member 12; and a structure may also be employed, in which the upper surface of the electrode group 1 is pressurized by a suitable force via the vertical deviation curb member 6C by means of the size of the battery can and the thickness of the electrode group.

It is sufficient if the above position limit portion 11g is so structured as to curb lateral deviation of at least two opposite side surfaces of the side surface portion of the electrode group 1. The at least two opposite side surfaces are the side surfaces on which the electricity collection terminals are disposed. Besides, the position limit portion 11g may be disposed on four side surfaces of the rectangular electrode group 1; in any structure, it is possible to firmly fix the electrode group 1 into the outer case 11 via the position limit portion 11g, the lid member 12 and the vertical deviation curb member 6C.

Besides, like in a secondary battery RB4 according to a fourth embodiment shown in FIG. 3B, an outer case 11B may be used, in which a concave position limit portion 11h is disposed on a bottom surface. In this case as well, a structure may also be employed, in which the upper surface of the electrode group 1 is pressurized via the lid member 12; and in a case where the lid member 12 does not pressurize the upper surface of the electrode group 1, a structure may also be employed, in which the upper surface of the electrode group 1 is pressurized by a suitable force via the vertical deviation curb member 6C.

Even in the structure of the fourth embodiment, it is possible to firmly fix the electrode group 1 into the outer case 11 via the position limit portion 11h, the lid member 12 and the vertical deviation curb member 6C.

It is preferable that the vertical deviation curb member 6C also has compressibility, flexibility and is formed of a foam material that has an insulation characteristic. Besides, if the vertical deviation curb member 6C has electrolyte permeability, even in the structure in which the upper surface of the electrode group 1 is pressurized via the lid member 12, the electrolyte permeates from the vertical deviation curb member 6C to the upper surface of the electrode group 1.

As described above, even in the structure that uses the vertical deviation curb member 6C formed of the foam material; and the concave and convex portion formed on the bottom surface of the outer case 11, the structure is obtained which includes the vertical deviation curb member for pressurizing the electrode group in the lamination direction and the lateral deviation curb member, so that it is possible to curb both of lateral deviation in the surface direction and vertical deviation in the lamination direction; and easily position and fix the electrode group into the outer case.

Besides, like in a secondary battery RB5 according to a fifth embodiment shown in FIG. 4A, a structure may be employed, which includes a lateral deviation curb member 6D formed at a position where lateral deviation of at least two opposite side surfaces of the side surface portions of the electrode group 1 is curbed; or like in a secondary battery RB6 according to a sixth embodiment shown in FIG. 4B, a structure may be employed, which includes a lateral deviation curb member 6E (convex member) that has a position limit convex portion at a position where lateral deviation of the at least two opposite side surfaces of the side surface portions of the electrode group 1 is curbed; or like in a secondary battery RB7 according to a seventh embodiment shown in FIG. 4C, a structure may be employed, which includes a lateral deviation curb member 6F (concave member) that has a position limit concave portion at a position where lateral deviation of the at least two opposite side surfaces of the side surface portions of the electrode group 1 is curbed.

Besides, it is preferable that all the lateral deviation curb members 6D, 6E and 6F have compressibility and flexibility and are formed of a foam material that has an insulation characteristic. Besides, according to the lateral deviation curb members 6D, 6E and 6F formed of a foam material that has electrolyte permeability, the electrolyte permeates from the side surface and bottom surface of the electrode group 1 where these members butt, so that it is possible to shorten the electrolyte injection time and further maintain the battery performance of the electrode group 1.

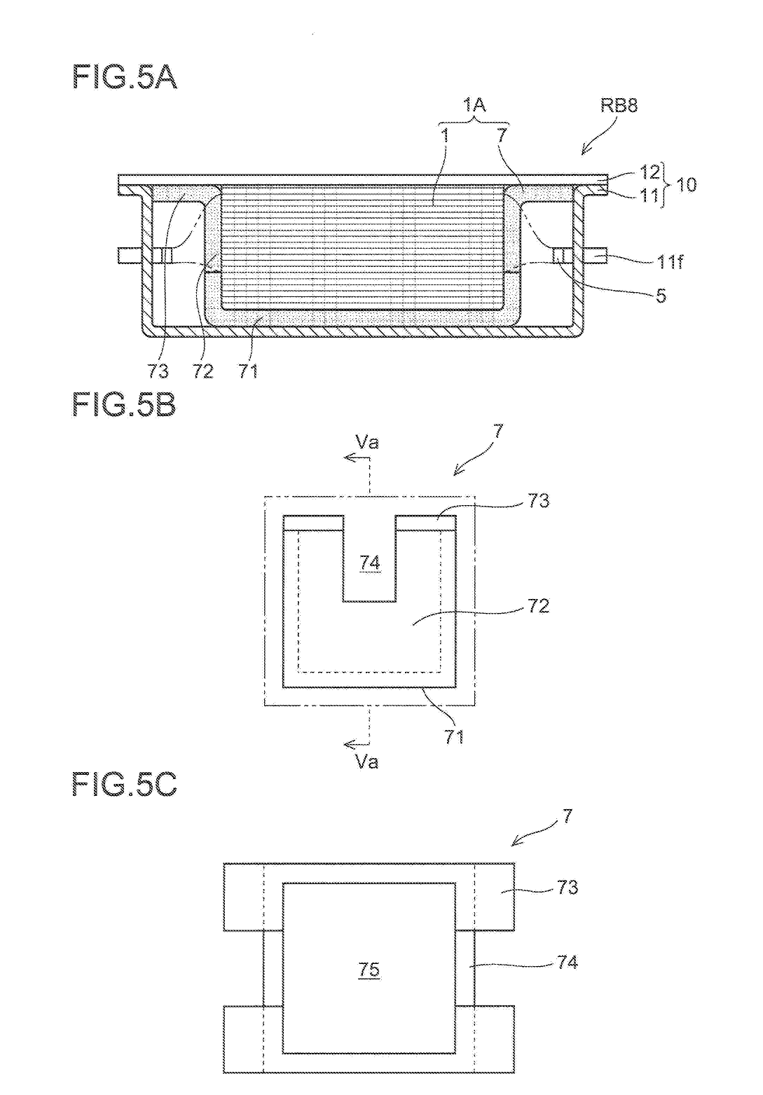

Next, an eighth embodiment, which has a structure in which a lamination fixture doubles as the lateral deviation curb member, is described by using FIG. 5A to FIG. 5C. FIG. 5A is a sectional view (Va-Va sectional view in FIG. 5B) showing a schematic structure of the entire eighth embodiment; FIG. 5B is a side view of the lamination fixture; and FIG. 5C is a plan view of the lamination fixture.

The present embodiment aims to shorten the production time of the secondary battery by laminating the electrode group 1 into a unit in advance. Because of this, as shown in FIG. 5A, a structure is employed, in which the electrode group 1 is housed and fixed into a dish shape (box-shape) lamination fixture 7, which is unitarily disposed into the outer case 11 that constitutes the battery can.

The lamination fixture 7 houses the electrode group 1 in a box-shape inside that is enclosed by a bottom portion 71 and four circumferential side portions 72; accordingly, it is possible to say that the lamination fixture 7 has inner surfaces which butt and support at least two opposite side surfaces of the side surface portions of the electrode group 1. Besides, a structure is employed, in which a tip of an upper edge portion 73 butts the inner surface of the outer case 11; accordingly, it is possible to say that the lamination fixture 7 has an outer surface which butts the inner surface of the outer case 11 to position and fix the surfaces which correspond to the above two side surfaces. Besides, according to this structure, the lamination fixture 7 is able to unitarily position and fix the electrode group 1 by performing the lateral deviation curb function. In other words, the lamination fixture 7 functions as the position fix member.

Besides, if the lamination fixture 7 is formed of a material (micro-porous foam material) that has electrolyte permeability, even in a structure in which the entire electrode group 1 is housed in the box shape that includes the bottom portion 71, the side portion 72 and the upper edge portion 73, the electrolyte becomes able to permeate from the side portion 72 and the bottom portion 71. Because of this, even in a structure in which the electrode group 1 is housed in the lamination fixture 7 in advance, by injecting the electrolyte after the electrode group 1 is built into the outer case 11, it is possible to let the electrolyte permeate into the inside of the electrode group 1 and use the lamination fixture 7 as the lateral deviation curb member.

Besides, as shown in FIG. 5B, an electrode group unit 1A having a unitary structure is employed, in which the side portion 72 is provided with an opening portion 74 through which the electricity collection terminal 5 is exposed; the positive-electrode plate, the negative-electrode plate and the separator are laminated; and further the electricity collection terminal 5 is built in, so that a structure is obtained, in which it is possible to disposed the electrode group unit 1A into the battery can as it is.

Because of this, each plate member, which forms the electrode group 1, is laminated in a housing portion 75 shown in the plan view of FIG. 5C to form the electro group 1; the electricity collection terminal 5 is disposed on the electrode group 1, which is unitarily built into the lamination fixture 7 to prepare the electrode group unit 1A. Thereafter, the electrode group unit 1A is built into the outer case 11 that constitutes the battery can; and the electricity collection terminal 5 is connected and fixed to the external terminal 11f. Then, the lid member 12 is disposed and the electrolyte is injected and tightly closed.

As described above, the lamination fixture 7 which doubles as the lateral deviation curb member is used, whereby it is possible to shorten the production time of the secondary battery and effectively curb positional deviation of the electrode group 1 after the electrode group 1 is built in. Besides, the upper edge portion 73 of the lamination fixture 7 is extended to be sandwiched by the outer case 11 and the lid member 12 to form a sandwich structure, which is further fastened with the sandwiched state, whereby it is possible to firmly fix the lamination fixture 7. In other words, it becomes possible to firmly fix the fix member that fixes the laminated type of electrode group 1 to the predetermined position of the outer case 11.

Next, the lithium secondary batteries actually prepared are described.

### EXAMPLES

### Preparation of Positive-Electrode Plate

LiFePO₄ (90 parts by weight) as the positive-electrode active material, acetylene black (5 parts by weight) as the electro-conductive material, and polyvinylidene fluoride (5 parts by weight) as the binding material are mixed; N-methyl-2-pyrrolidone as the solvent is suitably added to adjust slurry; this slurry is evenly applied onto both surfaces of aluminum foil (20 μm thick), which is the positive-electrode electricity collector, and dried; thereafter, compressed by a roll press; cut into a predetermined size to prepare positive-electrode plates 2.

Besides, the size of the prepared positive-electrode plate is 140 mm×250 mm, and the thickness is 230 μm; the positive-electrode plates 2 to the number of 32 are used.

### Preparation of Negative-Electrode Plate

Natural graphite (90 parts by weight) as the negative-electrode active material and polyvinylidene fluoride (10 parts by weight) as the binding material are mixed; N-methyl-2-pyrrolidone as the solvent is suitably added and the materials are dispersed to adjust slurry. This slurry is evenly applied onto both surfaces of copper foil (16 μm thick), which is as the negative-electrode electricity collector, and dried; thereafter, compressed by a roll press; cut into a predetermined size to prepare negative-electrode plates 3.

Besides, the size of the prepared negative-electrode plate is 142 mm×255 mm, and the thickness is 146 μm; the negative-electrode plates 3 to the number of 33 are used.

Besides, as the separator, polyethylene films, whose size is 145 mm×255 mm and thickness is 25 μm, to the number of 64 are prepared.

### Preparation of Nonaqueous Electrolyte

Ethylene carbonate (EC) and diethyl carbonate (DEC) are mixed at a volume ratio of 30:70 to form a mixed solution (solvent), into which 1 mol/L of LiPF₆ is dissolved to adjust a nonaqueous electrolyte.

### Preparation of Battery Can

A nickel-plated iron plate 0.8 mm thick is used as materials to prepare the outer case and the lid member that constitute the battery can. The battery can size is so designed to be 320 mm×150 mm×40 mm in inner dimension that is a long-direction length×a short-direction length×a depth of the outer case. However, in the case where the electrode group unit 1A is composed by using the lamination fixture 7 described in the eighth embodiment, the battery can size is so designed to be 320 mm×170 mm×40 mm. Besides, to tightly pressurize the lid member to the upper surface of the electrode group, a structure is employed, which does not use a flat-plate-shape lid member but uses a dish shape lid member that fits into the inside of the can. If the dish shape lid member is used, it becomes possible to prevent the lid member from moving when welding the lid member; and the welding work becomes easy. Besides, by changing the depth amount of the dish shape, it is possible to easily deal with a change of the thickness of the housed electrode group. Further, in the case of the dish shape, it becomes possible to increase the strength of the lid member and the strength of the battery can, which is preferable.

### Assembly of Second Battery

The positive-electrode plate and the negative-electrode plate are alternately laminated via the separator. Here, the 32 positive-electrode plates, the 33 negative-electrode plates, and the 64 separators are laminated such that the negative-electrode plate is situated outside the positive-electrode plate; then, a structure is employed, in which the laminated body is wound with a polyethylene film that has a thickness of 25 μm, the same thickness as the separator, whereby the electrode group (laminated body) is composed.

The size of the separator interposed between the positive- and negative-electrode plates is, as described above, 145 mm×255 mm, which is a little lager size than the positive-electrode plate (140 mm×250 mm) and the negative-electrode plate (142 mm×255 mm). According to this, it is possible to surely cover the active material layers formed on the positive-electrode plate and the negative-electrode plate. Besides, connection pieces of the electricity collection members (electricity collection terminal) are connected to an exposed portion of the positive-electrode electricity collector and an exposed portion of the negative-electrode electricity collector.

Besides, the lateral deviation curb member and the vertical deviation curb member are formed of a polyethylene foam material as the foam material that has the insulation characteristic. The polyethylene foam material is excellent in mechanical strength and anti-chemical characteristic, further in resistance to heat as well; accordingly, is preferable as the foam material that is used for the present embodiments. The foam material is cut into a predetermined size and built in; the electrode group is housed into the outer case; the electricity collection terminal and the external terminal are connected to each other; and the lid member is disposed and fixed. Besides, the nonaqueous electrolyte is injected from the liquid injection opening; after the injection, the liquid injection opening is closed, whereby five secondary batteries are prepared for each the embodiments.

An example 1 is a secondary battery that corresponds to the secondary battery RB1 according to the first embodiment; and is composed by using the step-shape fix member 6A formed of a foam material that has a thickness of 10 mm. Besides, the width of the foam material is about the same as the width of the electrode group 1. An example 2 is a secondary battery that corresponds to the secondary battery RB2 according to the second embodiment; and is composed by using the stool-shape fix member 6B formed of a foam material that has a thickness of 10 mm. Besides, the width of the foam material also is about the same as the width of the electrode group 1.

An example 3 is a secondary battery that corresponds to the secondary battery RB3 according to the third embodiment; and is an example in which the convex position limit portion 11g having a height of 3 mm is disposed on the bottom surface of the outer case. An example 4 is a secondary battery that corresponds to the secondary battery RB4 according to the fourth embodiment; and is an example in which the concave position limit portion 11h having a depth of 3 mm is disposed on the bottom surface of the outer case.

An example 5 is a secondary battery that corresponds to the secondary battery RB5 according to the fifth embodiment; and is an example which includes a foam material having a height of 15 mm as the lateral deviation curb member 6D at the position where lateral deviation of at least two opposite side surfaces of the side surface portions of the electrode group is curbed. An example 6 is a secondary battery that corresponds to the secondary battery RB6 according to the sixth embodiment; and is an example which includes the lateral deviation curb member 6E that has position limit convex portions at positions where lateral deviation of at least two opposite side surfaces of the side surface portions of the electrode group is curbed. An example 7 is a secondary battery that corresponds to the secondary battery RB7 according to the seventh embodiment; and is an example which includes the lateral deviation curb member 6F that has position limit concave portions at positions where lateral deviation of at least two opposite side surfaces of the side surface portions of the electrode group is curbed. The widths of these lateral deviation curb members 6D, 6E and 6F also are about the same as the width of the electrode group 1.

Besides, an example 8 is a secondary battery that corresponds to the secondary battery RB8 according to the eighth embodiment; and is an example in which the electrode group is so housed and fixed as to be a unit in advance into the box-shape lamination fixture 7 that is formed of a foam material that has a plate thickness of 10 mm. Besides, the lid member is used to pressurize the upper surface of the electrode group 1.

### Preparation of Comparison Example

As a secondary battery of a comparison example, a secondary battery, which does not use the lateral deviation curb member and the vertical deviation curb member, is prepared. Because of this, the gap between the electrode group disposed in the battery can and the inner surface of the can is about 32 mm that is obtained from a difference between the long dimension 255 mm of the separator and the long dimension 320 mm of the battery inner dimensions. In this case as well, the structure is employed, in which the bottom surface of the lid member, which fits into the outer case, is tightly pressurized to the upper surface of the electrode group. In other words, it is the structure in which movement of the electrode group in the lamination direction is curbed.

The five examples of each of the first to eighth examples and five comparison examples are used to perform impedance measurements after the charge capacity is confirmed; and after predetermined vibration tests are performed, the impedance measurements are performed again. Besides, secondary batteries, in which a major change occurs when the impedance measurements are performed again, are disassembled and it is checked whether the connection portions are damaged or not. The experimental results are shown in a table 1.

TABLE 1

| | | battery size | the number | trouble | damage |
|---|---|---|---|---|---|
| | | length | of | after | to con- |
| | battery | width depth | prepared | vibration | nection |
| | type | (mm) | samples | test | portion |
| example 1 | laminated | 320 × 150 × | 5 | 0/5 | — |
| | type | 40 | | | |
| example 2 | laminated | 320 × 150 × | 5 | 0/5 | — |
| | type | 40 | | | |
| example 3 | laminated | 320 × 150 × | 5 | 0/5 | — |
| | type | 40 | | | |
| example 4 | laminated | 320 × 150 × | 5 | 0/5 | — |
| | type | 40 | | | |
| example 5 | laminated | 320 × 150 × | 5 | 0/5 | — |
| | type | 40 | | | |
| example 6 | laminated | 320 × 150 × | 5 | 0/5 | — |
| | type | 40 | | | |
| example 7 | laminated | 320 × 150 × | 5 | 0/5 | — |
| | type | 40 | | | |
| example 8 | laminated | 320 × 150 × | 5 | 0/5 | — |
| | type | 40 | | | |
| comparison | laminated | 320 × 150 × | 5 | 4/5 | 4/4 |
| example 1 | type | 40 | | | |

The vibration test is performed in each of 3-axis directions (x axis, y axis, z axis) for 3 hours and 45 minutes (11 hours and 15 minutes in total); 15 sets are performed, 15 minutes for each set (3 hours and 45 minutes), an frequency change of 5 Hz to 200 Hz and down to 5 Hz, and an acceleration change of 1 G to 8 G and down to 1 G.

As results of the experiment, in all of the example 1 (corresponds to the first embodiment) to the example 8 (corresponds to the eighth embodiment), no trouble occurs and the battery performances are in a usual state. However, in the comparison examples 1 that do not use the lateral deviation curb member and the vertical deviation curb member, trouble occurs in four of the five examples; according to disassembly inspection, the connection portions are damaged in all of the four samples in which the trouble occurs.

Even in the comparison example, it is possible to pressurize the electrode group via the lid member; however, as is understood from the experimental results, it is difficult to curb deviation (lateral deviation) in the lamination surface direction. Because of this, it is possible to say that it is preferable to curb lateral deviation of the electrode group by using the lateral deviation curb member indicated in the embodiments 1 to 8.

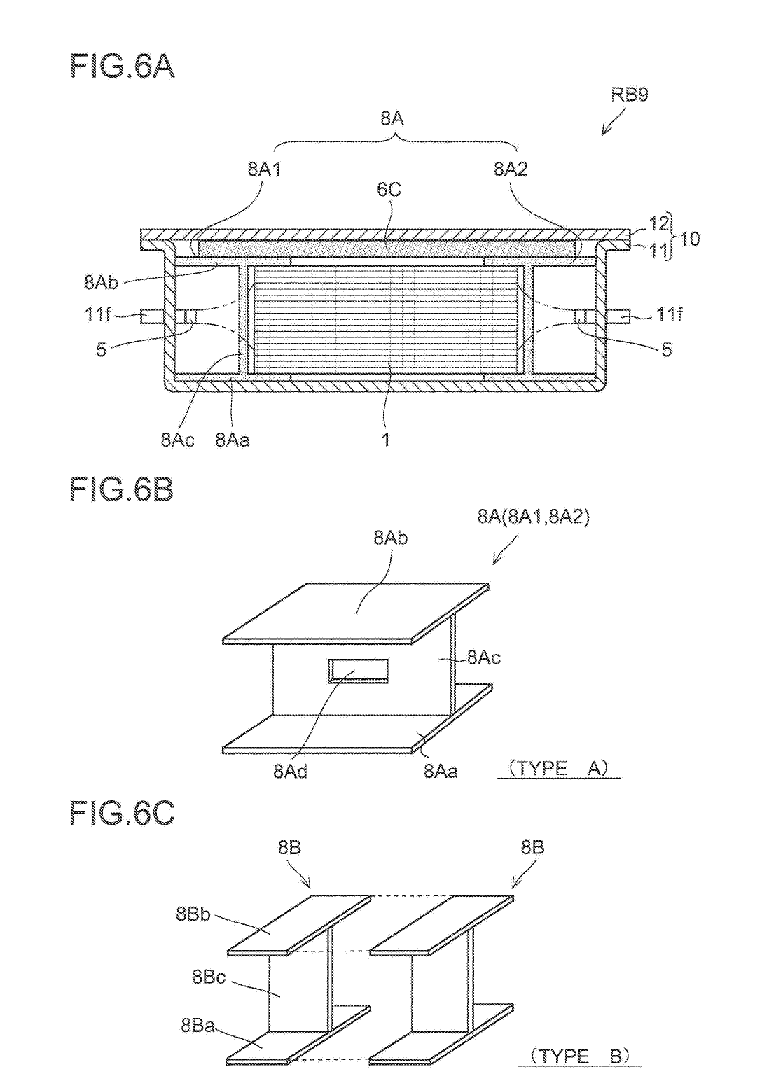

Next, secondary batteries, which have a structure in which the electrode group 1 is fixed by using deviation curb members in a ninth embodiment to an eleventh embodiment, are described by using FIG. 6 to FIG. 8.

FIG. 6A shows a sectional view of a secondary battery RB9 according to the ninth embodiment which disposes a deviation curb member 8A that unitarily includes a lateral deviation curb surface and a vertical deviation curb surface. Besides, FIG. 6B shows a schematic perspective view of the deviation curb member 8A; and FIG. 6C shows a deviation curb member 8B according to a modification that is divided into small width pieces.

As shown in FIG. 6B, the deviation curb member 8A (8A1, 8A2) (type A) is a deviation curb plate frame having an H shape in section that includes: a lower surface limit portion 8Aa and an upper surface limit portion 8Ab that are each a flat-surface shape; and a side surface limit portion 8Ac that is a vertical plate which connects the lower surface limit portion 8Aa and the upper surface limit portion 8Ab to each other over a predetermined distance and limits lateral deviation of the electrode group. Besides, the side surface limit portion 8Ac is provided with an opening (opening window portion 8Ad) for the electricity collection terminal. And, the material of the deviation curb member 8A is a resin material that has an insulation characteristic.

And, as shown in FIG. 6A, the deviation curb members 8A (8A1, 8A2) are disposed to both side surfaces that have the electricity collection terminals 5 of the electrode group 1 to sandwich the electrode group 1. In other words, a structure is obtained, in which the electrode group 1 is sandwiched in the lamination direction by the lower surface limit portion 8Aa and the upper surface limit portion 8Ab; and the side portions in the width direction of the electrode group 1 are sandwiched by the side surface limit portions 8Ac on both sides.

As described above, the deviation curb member 8A (8A1, 8A2) is the deviation curb member that unitarily includes: the lateral deviation curb surface (side surface limit portion 8Ac) that limits positional deviation of the side surface on which the electricity collection terminal 5 of the electrode group 1 is disposed; and the vertical deviation curb surface (lower surface limit portion 8Aa and upper surface limit portion 8Ab) that limits displacement in the lamination direction of the electrode group 1.

Even the deviation curb member 8A having the plate-frame shape serves as the fix member that fixes the electrode group 1 to a predetermined position in the outer case. Besides, a structure may be employed, in which the above vertical deviation curb member 6C having the compressibility and flexibility is so interposed between the lid member 12 and the deviation curb member 8A as to pressurize the deviation curb member 8A for holding the electrode group by means of a suitable force.

Besides, even in a structure in which the small-width deviation curb members 8B (type B) shown in FIG. 6C obtained by dividing the deviation curb member 8A into the small width are engaged with a total of four positions of the side portion end surfaces of the electrode group 1, the deviation curb member 8B has a function to fix the electrode group 1 to the predetermined position in the outer case. The deviation curb member 8B is formed of an insulation member having an H shape in section that includes: a lower surface limit piece 8Ba that butts the lower surface portion of the electrode group 1; an upper surface limit piece 8Bb that butts the upper surface portion of the electrode group 1; and a side surface limit piece 8Bc that is a vertical plate for connecting the lower surface limit piece 8Ba and the upper surface limit piece 8Bb to each other and limits lateral deviation of the electrode group, all of which have a small width and a piece shape. According to this structure, the deviation curb plate frames having the H shape in section are so disposed on the four corners of the electrode group as to sandwich both side surfaces and unitarily disposed, whereby it is possible to effectively curb positional deviation of the electrode group. In other words, the small-width deviation curb member 8B also serves as a deviation curb member that unitarily includes the lower surface limit surface, the upper surface limit surface and the lateral deviation limit surface.

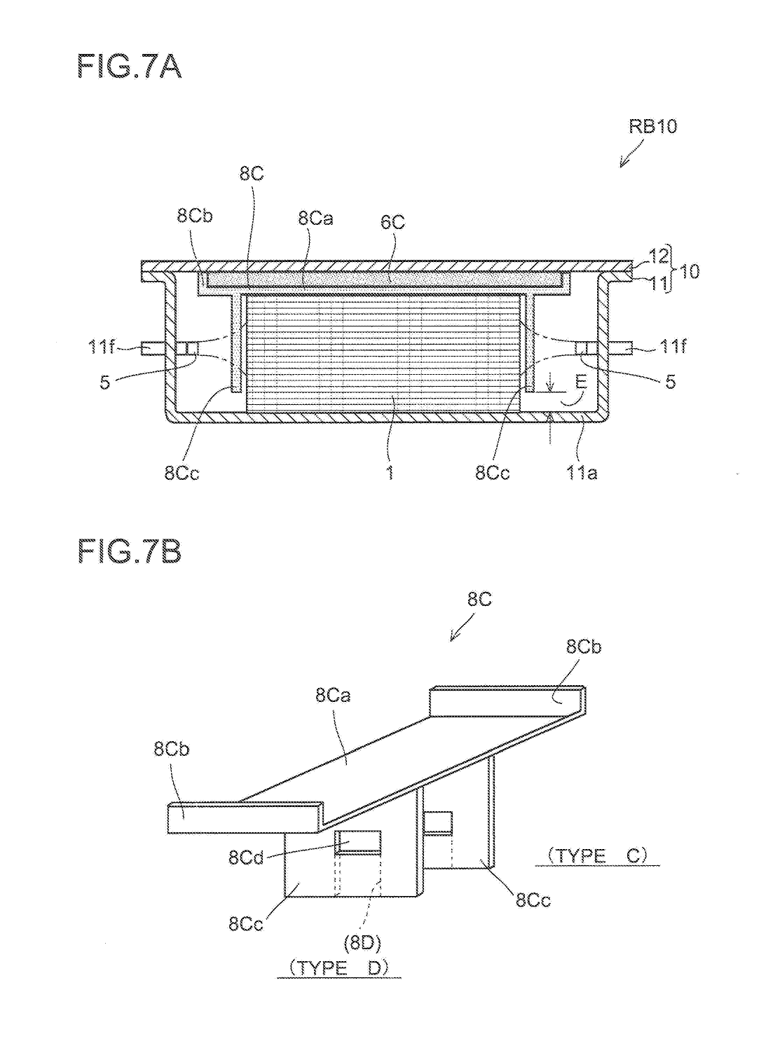

Besides, a deviation curb member 8C (type C) having a π shape in section as shown in FIG. 7A, FIG. 7B may be used to compose the fix member that fixes the electrode group 1 to a predetermined position in the outer case.

This deviation curb member 8C of a secondary battery RB10 according to the tenth embodiment includes: an upper surface limit portion 8Ca; a pair of leg-shape hang portions 8Cc; and the π shape in section. Besides, the upper surface limit portion 8Ca may be provided with bent-up pieces 8Cb at both ends.

In the deviation curb member 8C, as shown in FIG. 7A, the electrode group 1 is housed between the pair of side hang portions 8Cc and the upper surface limit portion 8Ca is pressurized to the upper surface of the electrode group 1. As a result of this, the upper surface limit portion 8Ca butts the entire upper surface of the electrode group 1 to fix the electrode group 1 to the predetermined position in the outer case. Besides, to exert a predetermined pressurization force, the side hang portion 8Cc and the bottom portion 11a of the outer case 11 do not touch each other to form a gap E.

In other words, if the deviation curb member 8C is disposed on the electrode group 1; the lid member 12 is disposed and pressurized in plane fashion, the lid member 12 butts and pushes down the bent-up portion 8Cb of the deviation curb member 8C; and the upper surface limit portion 8Ca pushes down the upper surface of the electrode group 1 to fix the electrode group 1.

Here, a structure may be employed, in which the above vertical deviation curb member 6C having the compressibility and flexibility is interposed between the lid member and the deviation curb member 8C; and the upper surface of the deviation curb member 8C is evenly pushed and pressurized by means of a suitable force. The vertical deviation curb member 6C is disposed between the bent-up pieces 8Cb on both of the left and right sides, so that during the fixing work performed by pushing the lid member 12, the deviation curb member 6C does not deviate nor come off.

Besides, as shown in FIG. 7B, the side hang portion 8Cc is provided with an opening (opening window portion 8Cd) for the electricity collection terminal. The opening portion may be a rectangular opening window portion as shown in the figure, or a cut-away opening portion as shown by a broken line in the figure. Besides, the deviation curb member having the side hang portion that has the cut-away opening portion is indicated by 8D (type D).

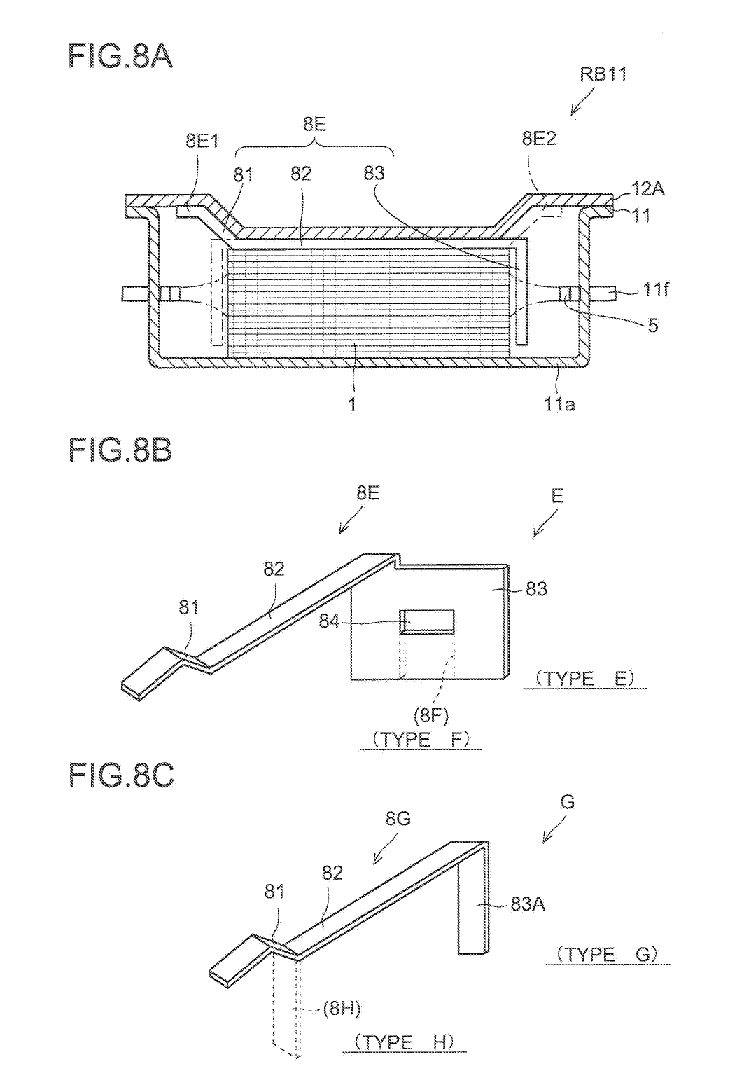

Besides, a deviation curb member having a structure, which is provided with a pair of left and right deviation curb pieces that do not have the H shape nor the π shape in section but have a L shape in section, may be used. Here, if the lid member is a lid member 12 A that does not have a flat-plate shape but has a dish shape, it is possible to use concaves and convexes of the dish shape to position and fix the deviation curb member. This embodiment is described by using FIG. 8.

As shown in FIG. 8A, if the lid member 12A has a dish shape that is concave at a central portion, a deviation curb member 8E (8E1, 8E2) is formed, which has a shape that is provided with: an engagement portion 81 that engages with a slope of the concave portion; an upper surface limit piece 82 that butts the upper surface of the electrode group 1; and a side hang portion 83 that limits positional deviation of the side surface of the electrode group 1. The side hang portion 83 also, like the above side hang portion 8Cc, does not touch the bottom portion 11a of the outer case 11 to form a gap.

For example, by using the deviation curb member 8E (type E) that includes: the plate-shape side hang portion 83 which is provided with an opening portion (opening window portion 84) for the electricity collection terminal; the engagement portion 81; and the upper surface limit piece 82, a fix means for fixing the electrode group 1 to a predetermined position in the outer case is composed. Besides, a deviation curb member is indicated by 8F (type F), which instead of the rectangular opening window portion 84, has a side hang portion having an opening cut-away portion shown by a broken line in the figure.

Besides, a deviation curb member 8G (type G) is formed, which includes a side hang portion (called a side hang piece 83A) that does not have a plate shape but has a small-width piece shape. Further, a deviation curb member 8H (type H) may be formed, which is provided with a pair of vertical pieces 83A as shown by a broken line in the figure to position both sides of the electrode group 1.

The width of the piece-shape deviation curb member may be about 10 to 20 mm; in the present embodiment, a polyethylene foam material having a thickness of 3 mm and a width of 15 mm is used. Besides, for the surface-shape deviation curb member, a polyethylene foam material is used, which has: a surface area that is about the same as or a little smaller than the surface of the electrode group (the separator is 145 mm×255 mm); and a thickness of 3 mm.

A material of the deviation curb member may be polypropylene that has already an achievement as a battery separator material. Besides, resin materials such as a polyimide resin, an aramid resin and the like that have stability in the electrolyte and thermal stability may be used; however, these materials are relatively expensive, which cause high cost.

Besides, the width of the electricity collection terminal is about 30 mm, and the widths of the opening window portion and the opening cut-away portion are about 40 mm larger than the width of the electricity collection terminal. Besides, when the thickness of the electrode group is about 40 mm, the height of the side hang portion is about 30 mm.

In other words, the type A of deviation curb member 8A having the H shape in section is prepared by using: upper and lower limit surfaces each having a size of 50×130; and a connection vertical plate (side surface limit portion) of 40×130. The type B has the width that is cut down to 15 mm; the types C, D having the π shape in section have a thickness of 3 mm and are prepared by using an upper surface limit portion of 300×130 and a side hang portion of 30×130.

The types E to G have the L shape in section: the type E includes the piece-shape upper surface limit piece on the side hang portion and is provided with the opening window portion; the type F is provided with the opening cut-away portion; and the type G includes a side hang piece as the side hang portion, and the upper limit piece. Besides, another side hang piece is disposed on the G type to approximate the π shape in section, which is the H type called the Lit type in the figure. The widths of these piece-shape portions are 15 mm as described above.

Besides, the type A is disposed on both side portions, accordingly, the number of the fixtures used is 2; the type B is disposed on both end portions of each of both side portions, accordingly, the number of the fixtures is 4; as the types C and D, one fixture is required each; the types E to H are each disposed on both side portions, accordingly, two fixtures are required each. Besides, as the type G, two fixtures on one side, that is, four fixtures may be disposed on both sides; and in the present embodiment, four fixtures are disposed to perform the experiment.

Besides, the type A having the H shape in section is easy to dispose, but has a loose lamination-direction limitation; the type C having the π shape in section has a strong lamination-direction limitation, but the setting takes a long time. Besides, the structure receiving the electrode group with the surface has a high deviation curb effect, but the electrolyte permeability is not enough. Besides, the structure receiving the electrode group with the piece has a good electrolyte permeability, but does not have a high deviation curb effect. Besides, as for the opening portion, the open type of opening cut-away portion is easier than the closed type of opening window portion in setting.

Five secondary batteries are prepared for each of the type A to the type H of deviation curb members 8A to 8H; and five secondary batteries are prepared as one comparison example like in the above-described example; impedance measurements are performed after the charge capacity is confirmed; and after predetermined vibration tests are performed, the impedance measurements are performed again. Besides, secondary batteries, in which a major change occurs when the impedance measurements are performed again, are disassembled and it is checked whether the connection portions are damaged or not. The experimental results are shown in a table 2.

TABLE 2

| | sectional | | the | | damage |
|---|---|---|---|---|---|
| | shape (the | | number of | | to con- |
| example | number of | terminal | prepared | | nection |
| (type) | fixtures) | opening | samples | trouble | portion |
| A | H shape (2) | window type | 5 | 0/5 | no |
| B | H shape (4) | not provided | 5 | 0/5 | no |
| C | π shape (1) | window type | 5 | 0/5 | no |
| D | π shape (1) | cut away | 5 | 0/5 | no |
| E | L shape (2) | window type | 5 | 0/5 | no |
| F | L shape (2) | cut away | 5 | 0/5 | no |
| G | L shape (4) | not provided | 5 | 0/5 | no |
| H | Lπ shape (2) | not provided | 5 | 0/5 | no |
| comparison | no fixtures | not provided | 5 | 4/5 | 4/4 |
| example 2 | | | | | |

The vibration test is performed in each of 3-axis directions (x axis, y axis, z axis) for 3 hours and 45 minutes (11 hours and 15 minutes in total); 15 sets are performed, 15 minutes for each set (3 hours and 45 minutes), an frequency change of 5 Hz to 200 Hz and down to 5 Hz, and an acceleration change of 1 G to 8 G and down to 1 G.

As results of the experiment, in all of the type A (corresponds to the ninth embodiment) to the type H (corresponds to the eleventh embodiment), no trouble occurs and the battery performances are in a usual range. However, in the comparison examples 2 that do not use any type of deviation curb member, trouble occurs in four of the five examples; according to disassembly inspection, the connection portions are damaged in all of the four samples in which the trouble occurs.

In other words, it is clear that in the comparison example 2, deviation occurs to damage the terminal connection portion. Even in the comparison example 2, it is possible to curb deviation (vertical deviation) in the lamination direction to some extent by employing the structure to pressurize the lid member to the electrode group; however, it is difficult to sufficiently curb deviation (lateral deviation) in the lamination surface direction. Because of this, it is possible to say that it is preferable to effectively curb vertical deviation and lateral deviation of the electrode group by using the type A to type H of deviation curb members (fix means).

All of the above type A to type H are able to curb vertical deviation and lateral of the electrode group; however, from the viewpoint of battery production processes, it is preferable that the process of inserting the electricity collection tab through the opening portion is not required; accordingly, the type B having the opening cut-away portion is more preferable than the type A; the type D is more preferable than the type C; and the type F is more preferable than the type E.

Besides, these type B, type D and type F each having the opening cut-away portion do not need to consider the pulling-out of the electricity collection tab, so that it is possible to make them tightly touch the side surface of the electrode group, which is preferable in terms of lateral deviation curb function.

As described above, in the present invention, the structure is employed, in which the fix member is so disposed as to fix the laminated type of electrode group to the predetermined position in the outer case, so that even in a structure in which the electrode group is housed in a large battery can for a large capacity, it is possible to obtain the secondary battery that effectively curbs deviation, surely positions and fixes the electrode group.

Besides, according to the structure in which the step-shape fix member and the stool-shape fix member each unitarily having the lateral deviation curb member and the vertical deviation curb member are interposed, it is possible to surely position and fix the electrode group into the outer case by curbing both of lateral deviation in the surface direction and vertical direction in the lamination direction. Because of this, it is possible to prevent damage to the terminal connection portion, stabilize the performance of the secondary battery, and achieve a long life as a product quality.

Besides, the fix means such as the curb member and the like, which unitarily includes: the lateral deviation curb member and the vertical deviation curb member; the lateral deviation curb surface and the vertical deviation curb surface, is formed of the foam material having the insulation characteristic, so that it becomes possible to achieve the insulation between the battery can and the electrode group, and curb lateral deviation and vertical deviation with the suitable force by means of the suitable compressibility and flexibility.

### INDUSTRIAL APPLICABILITY

Because of this, the secondary battery according to the present invention becomes preferably applicable to large-capacity storage accumulators that are required to have a large size and performance stability.

### REFERENCE SIGNS LIST

1 electrode group
1A electrode group unit
2 positive-electrode plate
3 negative-electrode plate
4 separator
5 electricity collection terminal
6A step-shape fix member
6B stool-shape fix member
6C vertical deviation curb member
6D,6E, 6F lateral deviation curb member
7 lamination fixture
8A to 8H deviation curb member
10 battery can
11 outer case
11f external terminal
12 lid member
RB, RB1 to RB11 secondary battery

1. A secondary battery comprising:
an electrode group comprising a separator laminated between a positive-electrode plate and a negative-electrode plate;
an outer case housing the electrode group and having an opening in a lamination direction of the electrode group,
a lid member connected to an edge of the opening of the outer case,
a lamination fixture structure comprising:
first side portion and second side portion configured to sandwich the electrode group in a direction perpendicular to the lamination direction of the electrode group,
a first fix member configured to fix placement of the first side portion relative to an inside wall of the outer case,
a second fix member configured to fix placement of the second side portion relative to the inside wall of the outer case.

2. The secondary battery according to claim 1 further comprising;
terminals piercing the outer case and having an external terminal provided outside of the outer case and a collection terminal provided inside of the outer case,
wherein the collection terminal is electrically connected to the positive-electrode plate and the negative-electrode plate of the electrode group.

3. The secondary battery according to claim 2 further comprising:
an opening portion provided on the side first and second portions; and
leads wires connecting the collection terminal to the positive-electrode plate and the negative-electrode plate through the opening portion.

4. The secondary battery according to claim 1, wherein the outer case is box-shaped.

5. The secondary battery according to claim 1, wherein the terminals are provided on a side wall of the outer case to face the first and second side portion respectively.

6. The secondary battery according to claim 1, wherein a planar direction of the positive-electrode plate and the negative-electrode plate is longer than the lamination direction of the electrode group.

7. The secondary battery according to claim 1, wherein interspaces are provided:
between the first side portion and the inside wall of the outer case facing the first side portion, and
between the second side portion and the inside wall of the outer case facing the first side portion.

8. The secondary battery according to claim 1, wherein the lid portion is configured to pressurize an upper surface of the electrode group to the electrode group.

9. The secondary battery according to claim 1, wherein the first and second fix member contact the lid member.

10. The secondary battery according to claim 1, wherein
the first fix member is configured to fix placement of the first side portion and an inside wall of the outer case facing the first side portion, and
the second fix member is configured to fix placement of the second side portion and an inside wall of the outer case facing the second side portion.
